(19) United States
(12) Patent Application Publication
(10) Pub. No.: US 2008/0127212 A1
(43) Pub. Date: May 29, 2008

(54) MEMORY LEAK DETECTING METHOD, MEMORY LEAK DETECTING DEVICE AND MEMORY LEAK DETECTING PROGRAM

(76) Inventors: Akiyoshi NAKAMIZO, Fujisawa (JP); Masatoshi YOSHIDA, Yokohama (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/851,723

(22) Filed: Sep. 7, 2007

(30) Foreign Application Priority Data
Nov. 27, 2006 (JP) 2006-318800

(51) Int. Cl. G06F 9/44

(52) U.S. Cl. 719/315

(57) ABSTRACT

A memory leak detecting method includes steps of corresponding an accepted request with an identifier to be specified to the accepted request to store a history of an executed processing in request trace information; deleting correspondence information of the accepted request and an object to be created when the object is created in the processing of the accepted request and corresponding information of the request and object when trace information of an object creation is recorded and a use of the created object is ended; recording trace information of an object release; acquiring a list of the requests in execution from the request trace information in accepting an instruction for detecting a memory leak; and detecting an object corresponding to the request as a suspicion of memory leak, in which the object corresponding the request is not included in the request list and is included in the correspondence information.

### INCORPORATION BY REFERENCE

The present application claims priority from Japanese application JP2006-318800 filed on Nov. 27, 2006, the content of which is hereby incorporated by reference into this application.

### BACKGROUND OF THE INVENTION

1. Field of the Invention

The present invention relates to techniques to distinguish a request which executes a processing occurred on a memory leak and specify causes of occurring the memory leak.

2. Description of the Related Art

In these years, a trend to demand a system for mainly implementing the service of Web base through Internet or Intranet has become high. In the case of developing such a system, a middleware referred to as an application server is used, and a technique for developing a user application which is executed in the application server has become widely used.

The application server provides a security management function, a transaction management function, an access function to resources, and a component management function. In this way, it is possible to relatively and easily develop a system having large scale and high reusability by using the application server.

For example, the application server accepts a request from a user to execute a given business processing. At this time, a user application executed in the application server stays in a memory of the application server to remain an area ensured in the memory if release of a use ended object is missed. For this reason, a usable idle memory space is decreased with elapse of the time in the application server. Such phenomenon is referred to as a memory leak.

On occurrence of the memory leak, the application server cannot continue executing the business processing since a necessary object cannot be created eventually for processing the request. Particularly, the application server has often a case where a plurality of user applications are executed as a multithread so that a plurality of requests are processed effectively. Therefore, there is a problem that it is impossible to implement the service of not only the user application which misses the release of object but also other user applications to be executed in the application server.

Further, the application server has a case of incorporating a function referred to as a garbage collection for releasing an unnecessary memory area automatically. However, even though the memory in system is released by the garbage collection, a memory leak occurs if the user application misses the release of reference to the use ended object.

Furthermore, the system for releasing the memory by the garbage collection executes a full garbage collection which once all of the threads being executed in the application server are stopped to search releasable objects, when the usable idle memory space is decreased. However, there arises a problem that the full garbage collection is therefore given frequently in steps and the response time of service becomes long, because not all leaked objects are released.

As described above, when a memory leak occurs in the user application executed in the application server, there is a problem that it is impossible to continue the service eventually. For this reason, it is important to specify quickly a location and a condition where a defect causes the memory leak, when the object or its reference is not released in the user application.

A number of methods for specifying a defective location which causes a memory leak and its cause have been proposed heretofore, for example, JP-A-11-203193. With use of the methods, a type and a quantity of unreleased objects can be specified, and a location where the object is created or referred to can also be specified for every process, job and thread.

On the other hand, a method for acquiring trace information of a request has been proposed for the application server. The trace information contains individually processed histories executed for implement of the requested business processing. For example, it contains various information in history while the request is processed, such as, time points when the processing of request starts and ends, time points when components constituted of a user application are extracted and returned from the extraction, time points when a back end system is extracted from a database and returned from the extraction, etc.

### SUMMARY OF THE INVENTION

In the method of related technique for specifying a memory leak and a defective location causing the memory leak, the type and quantity of unreleased objects can be specified, and the location where the object is created or referred to can also be specified for every process, job and thread.

However, in the user application, the memory leak had occurred in the case where a specific condition was satisfied, such that a specific type of request was processed, a program was executed by a specific order, for processing the request, etc. In the related technique, it is difficult to specify the condition of causing such memory leak.

An object of the invention is to provide techniques for specifying a condition of occurring a memory leak and the like caused by a request which occurs the memory leak, a processing order of the request, etc.

According to a typical aspect of the invention, a method for detecting a memory leak of a processing executed in accordance with an accepted request is carried out in an application server. The application server includes an interface, a processor connected with the interface, and an accessible memory from the processor, in which the processor executes the following steps: the accepted request is corresponded with an identifier to be specified to the accepted request to record a history of the processing executed in accordance with the accepted request as request trace information; correspondence information of the accepted request and an object created in a processing of the accepted request when the object is created in the processing of the accepted request; the creation of object created in the processing of the accepted request is recorded in the request trace information; the correspondence information of the accepted information and a use ended object is deleted when the use of object created in the processing of the accepted request is ended; a release of the completely use object is recorded in the request trace information; a request list in execution is acquired by searching requests, an ending history of which is not recorded in the request trace information, when the application server accepts an instruction to detect a memory leak; and an object corresponding to the request is detected as an object having a suspicion of memory leak, in which the object corresponding to the request is not included in the acquired request list in the execution and is included in the correspondence information of the accepted request and the object created in the processing of the accepted request.

According to the aspect of the invention, it is possible to specify easily a condition of causing a memory leak even in the case where the memory leak is only occurred in a specific condition caused by the defect of application.

Other objects, features and advantages of the invention will become apparent from the following description of the embodiments of the invention taken in conjunction with the accompanying drawings.

### BRIEF DESCRIPTION OF THE DRAWINGS

FIG. 1 is an explanatory diagram showing a device constitution in an embodiment of the invention;

FIG. 2A is an explanatory diagram showing an example of a request trace table in the embodiment of the invention;

FIG. 2B is an explanatory diagram showing an example of an object management table in the embodiment of the invention;

FIG. 3A is an explanatory diagram showing a processing flow of object management in a request processing in the embodiment of the invention;

FIG. 3B is an explanatory diagram showing a processing flow in the request processing and object creation in the embodiment of the invention;

FIG. 3C is an explanatory diagram showing a processing flow in an object release in the embodiment of the invention;

FIG. 4 is a flow chart of the object management processing in the request processing in the embodiment of the invention;

FIG. 5 is a flow chart showing steps of a user program processing in the embodiment of the invention;

FIG. 6 is a flow chart showing steps of an object creation processing in the embodiment of the invention;

FIG. 7 is a flow chart showing steps of an object release processing in the embodiment of the invention;

FIG. 8 is an explanatory diagram showing a flow of memory leak detection processing in the embodiment of the invention;

FIG. 9A is a diagram showing an example of an in-execution request list in the embodiment of the invention;

FIG. 9B is an explanatory diagram showing an example of leak object list in the embodiment of the invention;

FIG. 10 is an explanatory diagram showing an example of a screen of the memory leak detection processing in the embodiment of the invention;

FIG. 11 is a flow chart showing steps of the memory leak detection processing in the embodiment of the invention; and

FIG. 12 is a flow chart showing steps of deleting trace information stored in the request trace table in the embodiment of the invention.

### DESCRIPTION OF THE EMBODIMENTS

Embodiments of the invention will be described below with the reference to the drawings.

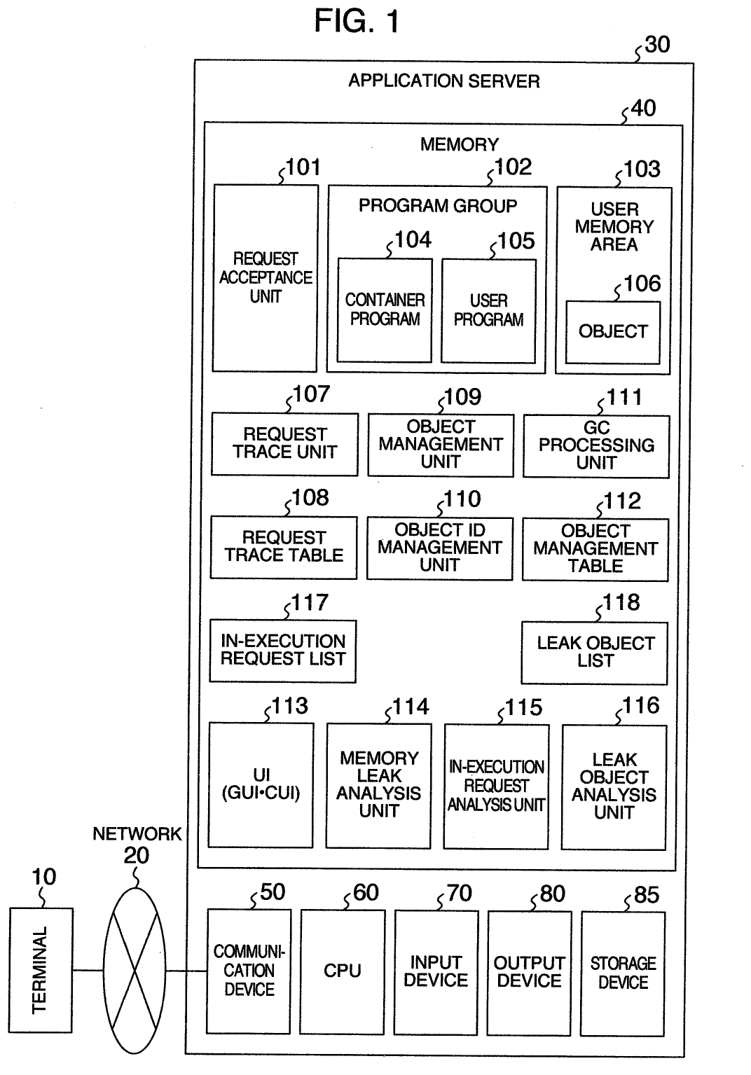

FIG. 1 is an explanatory diagram showing a schematic constitution of computer system in an embodiment of the invention. In the computer system, an application server 30 is connected with a terminal 10 through a network 20. The terminal 10 transmits a request for requesting an execution of business processing instructed by the application server 30.

The application server 30 includes a communication device 50, a CPU 60, an input device 70, an output device 80, a storage device 85, and a memory 40. The communication device 50 is connected with the network 20 corrected to the terminal 10. The CPU 60 executes programs stored in the memory 40.

The input device 70 is a device for accepting an input of information necessary for the application server 30, for example, accepting a detecting instruction for a memory leak from a user. The output device 80 displays information output from the application server 30, for example, displays a detected result of an object having suspicion of a memory leak. The storage device 85 stores programs and data necessary for executing the programs, and this is a hard disk, for example.

The memory 40 includes a request acceptance unit 101, a program group 102, a user memory area 103, a request trace unit 107, a request trace table 108, an object management unit 109, an object ID management unit 110, a GC processing unit 111, an object management table 112, a UI (User Interface) 113, a memory leak analysis unit 114, an in-execution request analysis unit 115, and a leak object analysis unit 116. In addition, units indicated by thick lines in FIG. 1 are of distinctive constitutions of the invention. The programs and data may be stored in the memory 40 in advance, and may also be read out from the storage device 85 at the execution.

The request acceptance unit 101 accepts a request transmitted from the terminal 10 to execute a container program 104. Further, the request acceptance unit 101 requests the request trace unit 107 to output histories from a start to end of a processing of the request.

The program group 102 is constituted by the container program 104, a user program 105, etc.

The user memory area 103 stores an object 106 created by programs constituting the program group 102.

The container program 104 executes a security control, a transaction control, etc. in the request processing, and also executes the user program 105.

The user program 105 is a program created by the user who requests to execute a business processing, and actually executes the business processing in accordance with the accepted request.

Further, the user program 105 requests the object management unit 109 to create an object to use the object 106 created in the user memory area, when the user program uses the object for processing the request.

Furthermore, the user program 105 releases all of references to the object 106 to remain the object 106 releasable in condition by the GC processing unit 111, when the user program ends the use of object 106. In this regard, if the release of reference to the object 106 which is ended as used is missed, a memory leak occurs because the GC processing unit 111 cannot release the object 106, in the case where there is a defect in the user program 105 and the like.

The request trace unit 107 is a processing unit for managing trace information of the request to make the trace information of request to be stored in the request trace table 108.

The object management unit 109 is a processing unit for managing the object 106 in the user memory area 103 to accept the request from the user program 105 and create the requested object 106. Further, the object management unit 109 accepts a request from the GC processing unit 111 to release the object 106 from the user memory area 103.

The object ID management unit 110 is a processing unit for managing a correspondence of the object 106 and the request. The object ID management unit 110 also registers and deletes the correspondence of the object 106 and the request in the object management table 112 in response to a request from the object management unit 109.

The GC processing unit 111 extracts an object to be able to discard among the objects 106 stored in the user memory area 103 to request the object management unit 109 to release the object, when an idle memory area becomes decreased in the user memory area 103.

The UI 113 is a user interface to accept a detection request of memory leak from a manager and instruct a memory leak detection to the memory leak analysis unit 114. In addition, the UI 113 may be of either GUI (Graphical User Interface) or CUI (Character_based User Interface). In addition, the UI 113 accepts an instruction of detecting a memory leak from the user to make an object list of objects having a suspicion of memory leak, a request list of requests which create the objects having the suspicion of memory leak, and the trace information of the designated requests to display on itself.

The memory leak analysis unit 114 receives an instruction of an analysis for a memory leak from UI 113 to request first the GC processing unit 111 to perform a full garbage collection for. A leak object list 118 is then created as an unreleased object from the memory by the in-execution request analysis unit 115 and leak object analysis unit 116, even though the request is already completed.

The in-execution request analysis unit 115 refers to the trace information stored in the request trace table 108 to create an in-execution request list 117 as a request list which does not record an event indicating that the request is completed.

The leak object analysis unit 116 refers to the in-execution request list 117 to acquire an object list, which is not in execution of the request, from the object management table 112. Namely, the leak object list 118 indicating that the reference is not released and discarded, is created even though the request is completed.

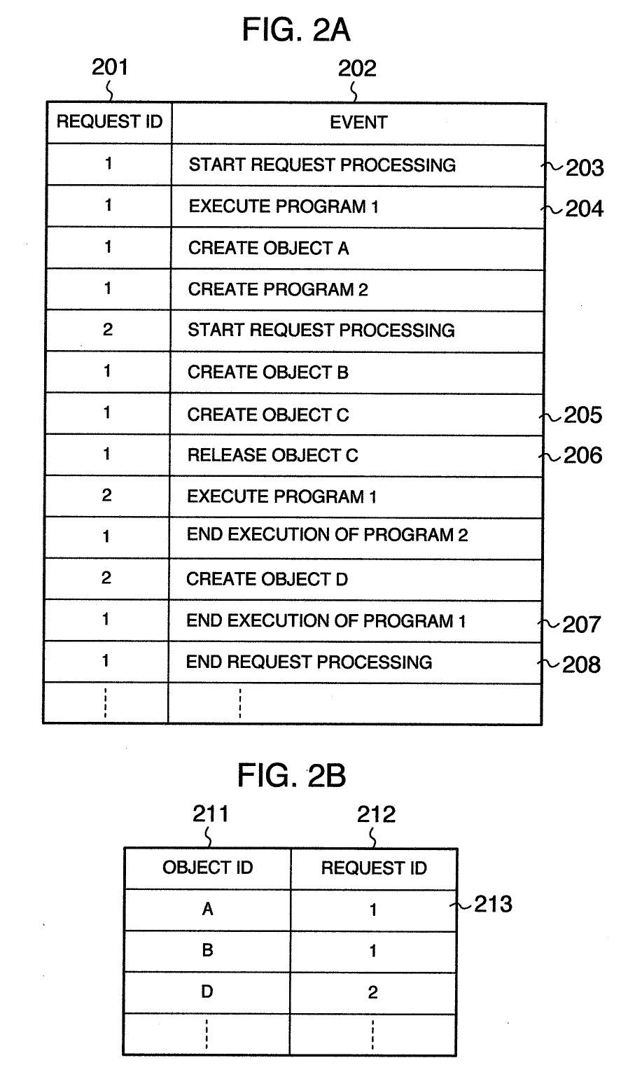

FIG. 2A is an explanatory diagram showing an example of the request trace table 108 in the embodiment of the invention. The request trace table 108 includes a request ID field 201 and an event field 202.

The request ID field 201 stores a request ID for uniquely identifying the accepted request from the terminal 10. The request ID is created by the request trace unit 107 in the request acceptance. The event field 202 records event information in the order of time series, for identifying processing points of executing the request.

The records to be recorded in the request trace table 108 are created for every processing point when the accepted request is processed, for example, when the request processing starts and ends, when the object is created and deleted, etc.

FIG. 2B is an explanatory diagram showing an example of the object management table 112 in the embodiment of the invention. The object management table 112 stores a correspondence relation between the request being processed and the object created by this process of the request, and also includes an object ID field 211 and a request ID field 212.

The object ID field 211 stores object IDs for identifying the created object. The object ID is created by the object ID management unit 110 in the creation of object.

The request ID field 212 is the same as the request ID field 201 in the request trace table 108, and stores request IDs of the request which creates objects to be identified by the object ID field 211.

The application server 30 records, in the object management table 112, the object ID for identifying the created object in the creation of object and the request ID created by the request acceptance unit 101 in the acceptance of request. In addition, the request ID may be recorded in the created object.

Here, a general processing will be described with the following steps so that a request is accepted from the terminal 10, the user program 105 necessary for the business processing is then executed, and an object is eventually created and released.

The processing of the accepted request is, as classified generally, constituted by a request start processing, a user program processing (object creation processing), and a request end processing.

Further, in the case of this embodiment of the invention, a garbage collection is executed at a predetermined timing by the GC processing unit 111, so that the object, which is ended as used, is released from the memory. At this time, the user program processing (object release processing) is executed by the object management unit 109.

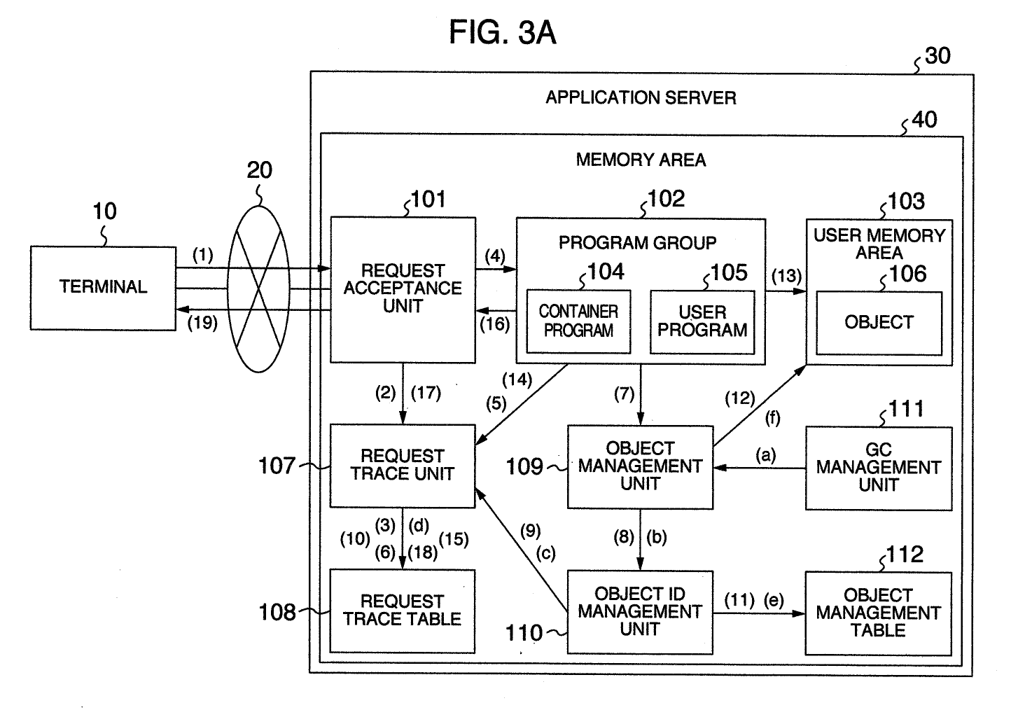

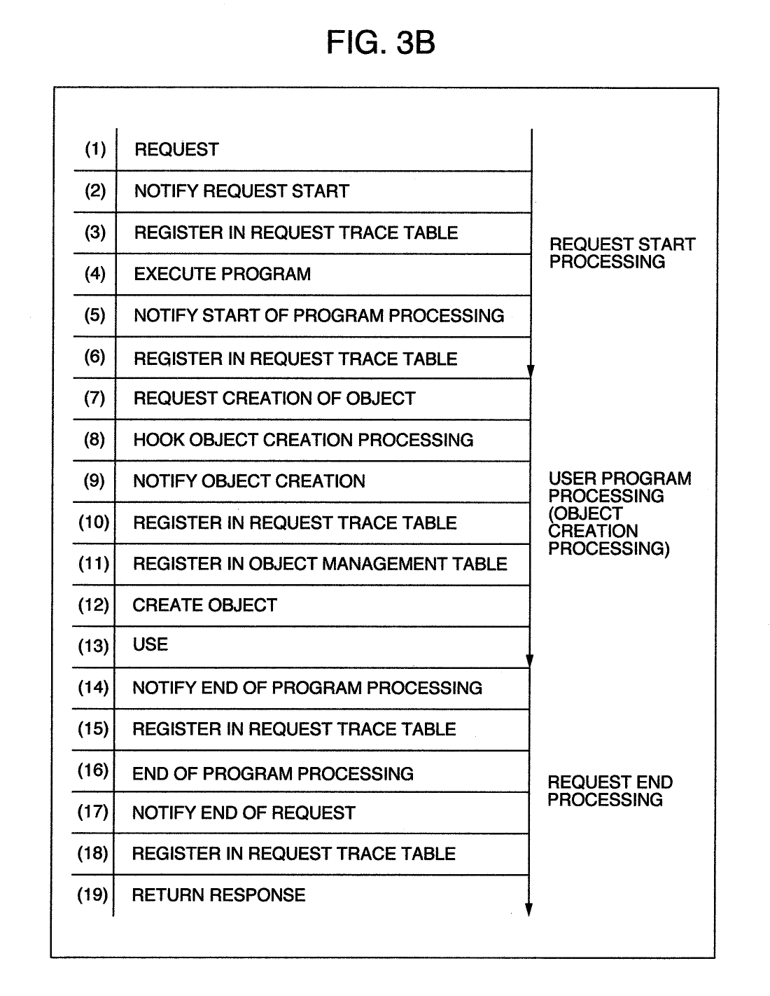

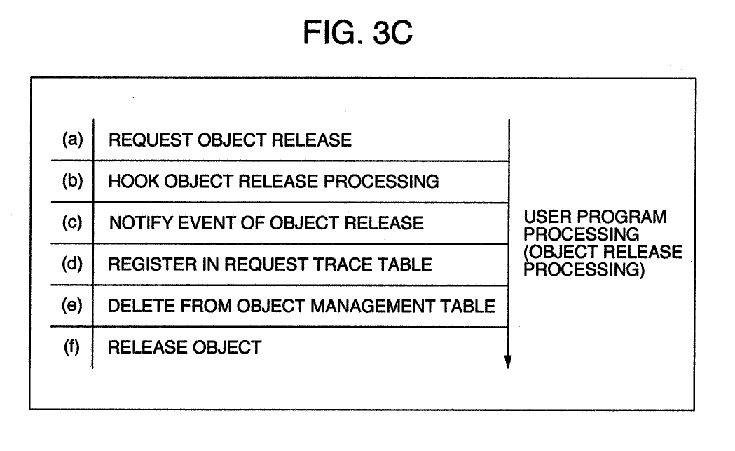

FIG. 3A is an explanatory diagram showing a processing flow of an object management in the request processing of the embodiment. Reference numerals and characters in brackets annexed to respective arrows show a processing order, which corresponds to reference numerals and characters designated in FIG. 3B and FIG. 3C.

FIG. 3B is an explanatory diagram showing a processing flow in the object creation of the request processing in the embodiment.

The request start processing will be described first. The terminal 10 transmits a request of business processing to the application server 30 through the network 20, referring to (1) in FIG. 3B.

The application server 30 receives the request transmitted from the terminal 10 by the request acceptance unit 101 to notify a start of the request processing to the request trace unit 107, referring to (2).

The request trace unit 107 creates a request ID for uniquely identifying the request to record events of the request ID and the notification of starting the request processing in the request trace table 108, referring to (3).

The request trace unit 107 records the events in the request trace table 108 by using the same request ID in the subsequent program processing for received requests, until a response is transmitted to the terminal 10.

Next, the request acceptance unit 101 starts the container program 104, referring to (4). The container program 104 notifies a start of the user program to the request trace unit 107 after executing a preprocessing for starting the user program 105, referring to (5).

The request trace unit 107 records the request ID and the event of notifying the start of user program in the request trace table 108, referring to (6).

The processing as described so far is the request start processing. Subsequently, the user program processing (object creation processing) is executed.

After that, the container program 104 executes the user program 105.

The user program 105 executes the business processing, and requests the object management unit 109 to create an object, as required, referring to (7).

The object management unit 109 hooks the object creation processing, referring to (8), to execute a processing of the object ID management unit 110. The meaning of hooking the object creation processing is that a request of creating an object is detected for the object management unit 109, and the processing of object ID management unit 110 is executed, before the object management unit 109 starts the object creation processing. The request of creating the object is then transmitted to the object management unit 109 to carry on the processing, when the processing of object ID management unit 110 is completed.

The object ID management unit 110 allocates the unique identifier to every object to notify the object creation to the request trace unit 107, referring to (9).

The request trace unit 107 records the request ID and the even of notifying the object creation in the request trace table 108, referring to (10).

After that, the object ID management unit 110 acquires the request ID from the request trace unit 107 to record it together with the created object ID in the object management table 112, referring to (11).

The object management unit 109 then ensures a memory area necessary for the creation of object 106 to the user memory area 103 to create the object 106, referring to (12), and transmits the object 106 to the user program 105.

The processing as described so far is the user program processing (object creation processing), and subsequently, the request end processing is executed.

The user program 105 ends the use of object 106 to release a reference to the object 106. The program in execution or the object 106 which is not referred from the objects is deleted (released) from the user memory area 103 by an after-mentioned object release processing.

The user program 105 returns a processing control to the container program 104 when the execution of business ends. The container program 104 then notifies the end of user program to the request trace unit 107, referring to (14).

The request trace unit 107 records the request ID and event of notifying the end of user program in the request trace table 108, when the end of user program 105 is notified, referring to (15).

Further, the container program 104 executes a postprocessing for the user program 105, thereafter, returns a processing control to the request acceptance unit 101, and ends the processing itself, referring to (16). After that, the request acceptance unit 101 notices the end of request to the request trace unit 107, referring to (17).

The request trace unit 107 records the request ID and event of notifying the request end in the request trace table 108, referring to (18). The request acceptance unit 101 then transmits a processing result of the user program 105 to terminal 10 as a response, referring to (19).

In the case of the procedure as described so far, a processing for releasing the created object 106 from the user memory area 103 is not included therein. However, a memory release processing is requested for the object management unit 109 from the user program 105, in the case where the garbage collection is not incorporated in a system.

Further, in the case of incorporating the garbage collection in the system, the object release processing is periodically or non-periodically executed separately from the request processing by GC processing unit 111. In this case, the GC processing unit 111 requests the object management unit 109 to execute the object release processing.

Here, description will be concerned with a processing in the object release.

FIG. 3C is an explanatory diagram showing a processing flow of the object release in the embodiment of the invention. The object release processing has one case executed explicitly by the user program 105 in the request processing and the other case executed in a predetermined timing separately from the request processing by the GC processing unit 111.

The object release processing is executed so that the object management unit 109 accepts a request, referring to (a). At this time, the object ID management unit 110 hooks the request of object release processing to then execute the processing thereof, referring to (b).

In the case where the object release processing is executed explicitly by the user program 105, the object ID management unit 110 notifies a release of the object to the request trace unit 107, referring to (c). The request trace unit 107 then records an event of notifying the object release in the request trace table 108, referring to (d).

The object ID management unit 110 deletes an object ID for the object 106, which is already released, from the object management table 112, referring to (e). After that, the object management unit 109 releases a memory area ensured in the user memory area 103 which was actually used by the object 106, referring to (f).

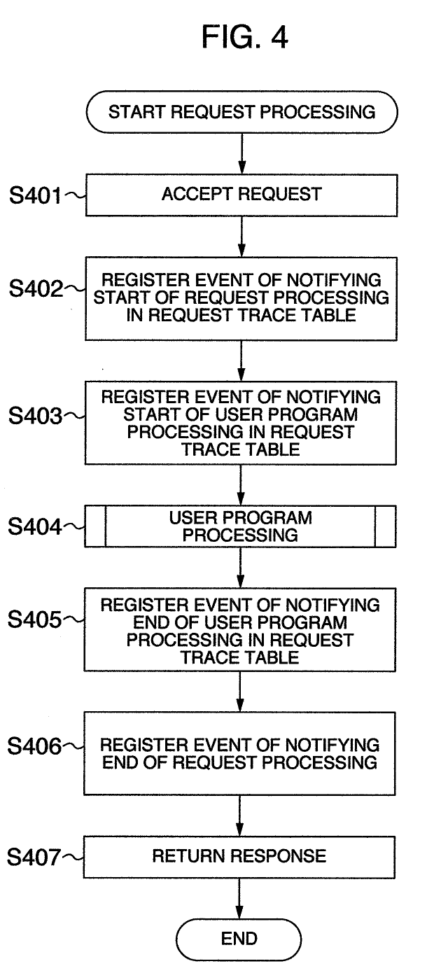

Subsequently, a detailed processing will be described with use of flow charts shown in FIG. 4 to FIG. 7 in which a request is accepted from the terminal 10, the user program 105 necessary for the business processing is then executed, and an object is eventually created and released.

FIG. 4 is a flow chart showing steps of the object management processing in the request processing of the embodiment.

First, the request acceptance unit 101 accepts a request transmitted from the terminal 10 through the network 20 (step S401). The request is an execution request of the business processing requested by a user. The request acceptance 101 accepts the request to notify a processing start of the request to the request trace unit 107.

The request trace unit 107 receives a notification of the processing start of request to create a request ID which is uniquely identifiable for the request. The created request ID and an event of notifying a start of request processing are thereby recorded in the request trace table 108 (step S402). Specifically, in the case where the created request ID is set to “1”, a request ID 201 is set to “1” and an event 202 is “start of request processing”, both of which are recorded in the request trace table 108 (a record 203 in FIG. 2A).

Subsequently, the request acceptance unit 101 executes the container program 104 which then notifies a processing start of the user program 105 to the request trace unit 107. The request trace unit 107 records the event of notifying the start of the user program processing together with the request ID in the request trace table 108, when the processing start of user program 105 is notified to the request trace unit 107 (step S403). Specifically, in the case where the user program is “program 1”, the request ID 201 is set to “1” and the event 202 is “execution of program 1”, both of which are recorded in the request trace table 108 (a record 204 in FIG. 2A).

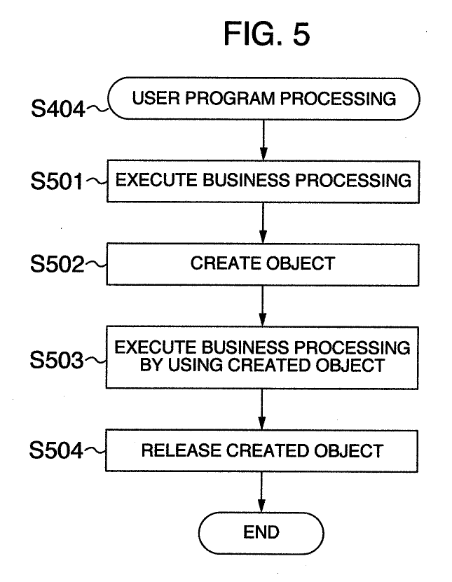

The container program 104 executes the user program 105 (step S404). A processing executed by the user program 105 will be described later with reference to FIG. 5.

The container program 104 notifies the end of processing the user program 105 to the request trace unit 107 when the processing of user program 105 is completed. The request trace unit 107 then records an event of notifying the end of user program together with the aforementioned request ID in the request trace table 108 (step S405). Specifically, the request ID 201 is “1” and the event 202 is “execution end of program 1”, both of which are recorded in the request trace table 108 (a record 207 in FIG. 2A).

After that, the control of processing is returned to the request acceptance unit 101 when the processing of container program 104 is completed. The request acceptance unit 101 notifies the end of request processing to the request trace unit 107 which then records the end of processing the request together with the request ID in the request trace table 108 (step S406). Specifically, the request ID 201 is “1” and the event 202 is “end of request processing”, both of which are recorded in the request trace table 108 (a record 208 in FIG. 2A).

Finally, the request acceptance unit 101 transmits an execution result of the user program 105 to the terminal 10 as a response (step S407).

FIG. 5 is a flow chart showing steps of the user program processing in the embodiment of the invention. This flow chart is a detailed processing of the step S404 in FIG. 4.

The user program 105 executes the business processing (step S501). A creation of objects is requested for the object management 109 at a time when an object is necessary for the processing.

The object management unit 109 ensures a memory area in the user memory area 103 to create the object 106 (step S502), then transmits the created object to the user program 105.

The user program 105 continues the business processing with use of the created object 106 (step S503), and then requests the object management unit 109 to release the object 106, when the business processing is completed and the object 106 becomes unnecessary.

The object management unit 109 receives the request for the release of object 106 to release the memory area used by the object 106 (step S504). At this time, a memory leak occurs in the case where the user program 105 does not execute the object release processing of the step S504. Particularly, an unreleased object 106 continues occupying the user memory area 103 if there is no garbage collection.

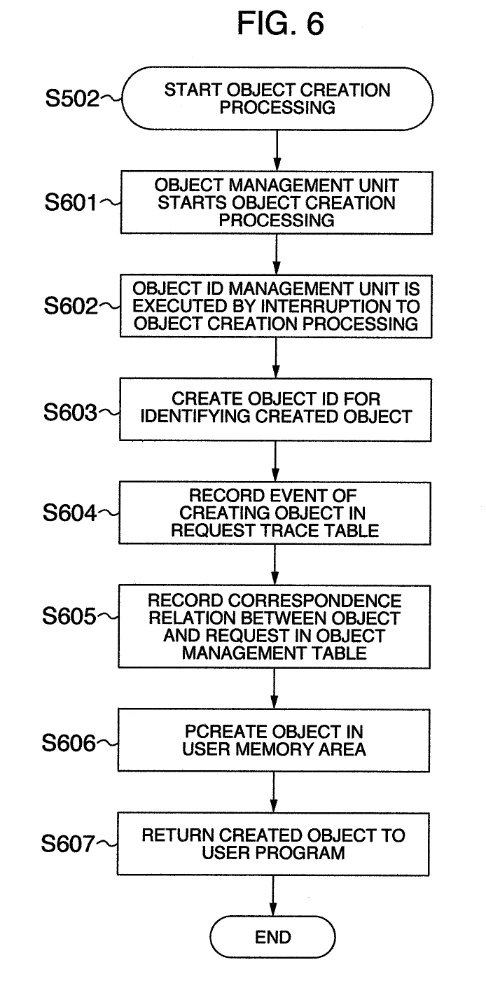

FIG. 6 is a flow chart showing steps of the object creation processing in the embodiment of the invention. This flow chart shows a detailed processing of the step S502 in FIG. 5.

The object management unit 109 is requested to create the object 106 by the user program 105 to start the object creation processing (step S601). At this time, the object ID management unit 110 hooks the object creation processing to then execute a processing itself (step S602).

The object ID management unit 110 creates an object ID to identify an object to be created (step S603), and notifies the creation of object to the request trace unit 107.

The request trace unit 107 receives a notification of the object creation to then specify clearly an event of the object creation to the object ID of the created object and record the event together with the request ID in the request trace table 108 (step S604). Specifically, in the case where a request indicating that the request ID is “1” creates an object C, the request ID 201 is “1” and the event 202 is “creation of object C”, both of which are recorded in the request trace table 108 (a record 205 in FIG. 2A).

The object ID management unit 110 records the object ID of the created object and the request ID created by the request trace unit 107 in the object management table 112 (step S605). Specifically, in the case where a request indicating that the request ID is “1” creates an object A, as shown in FIG. 2B, the object ID 211 is “A” and the request ID 212 is “1”, both of which are recorded in the object management table 112 (a record 213 in FIG. 2B).

After that, the object management unit 109 ensures an area in the user memory area 103 and creates an object 106 (step S606). The created object 106 is transmitted to the user program 105 (step S607).

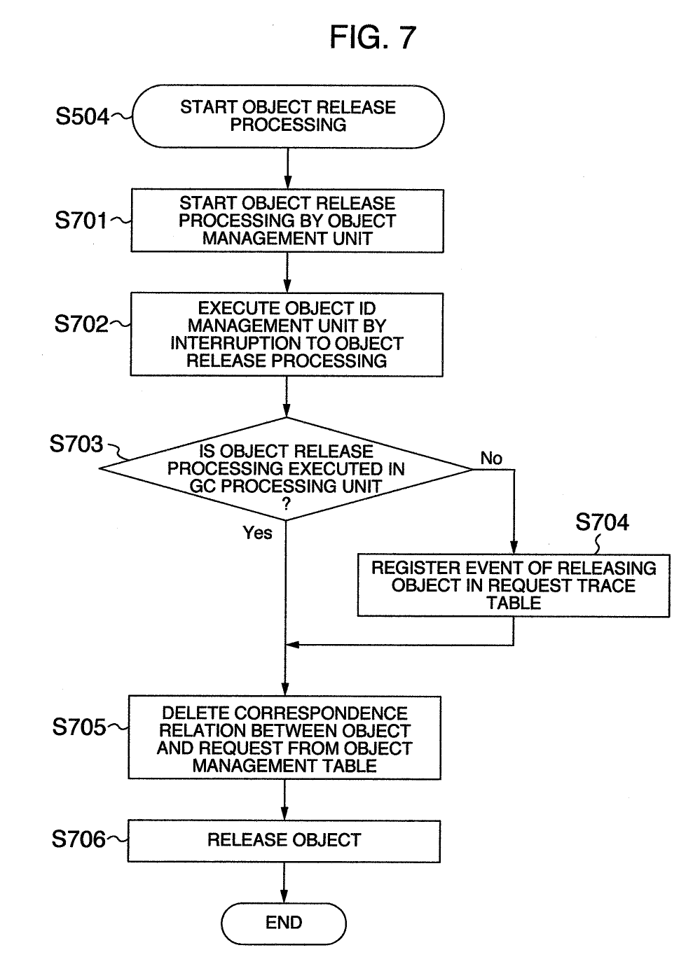

FIG. 7 is a flow chart showing steps of the object release processing in the embodiment of the invention. This flow chart shows a detailed processing of the step S504 in FIG. 5.

The object management unit 109 starts the object release processing by a request from either the user program 105 or GC processing unit 111 (step S701). The object ID management unit 110 hooks the object release processing to then execute a processing itself (step S702).

In the case where the object release processing receives a request from the user program 105 (a result of the step S703 is “No”), the object ID management unit 110 notifies a release of object to the request trace unit 107 because the object release processing is executed by the request processing.

The request trace unit 107 receives a notification of the object release to specify clearly an event of the object release to an object ID of the released object and record the event together with the request ID in the request trace table 108 (step S704). Specifically, in the case where a request indicating that the request ID is “1” releases the object C, the request ID 201 is “1” and the event 202 is “release of object C”, both of which are recorded in the request trace table 108 (a record 206 in FIG. 2A).

On the other hand, in the case where the object release processing is requested by the GC processing unit 111 (the result of the step S703 is “Yes”), the processing of a step S704 is not executed because the object release processing is not included in the request processing.

Further, the object ID management unit 110 deletes a correspondence relation between the object ID of the released object and the request ID from the object management table 112 (step S705). Furthermore, the object management unit 109 releases the memory area used by the object 106 (step S706).

Trace information indicating the creation and release of object recorded in the request trace table 108 is used, as information, for detecting an object having a suspect of memory leak and ascertaining causes of memory leak.

Subsequently, a procedure for detecting an object having a suspicion of memory leak will be described on the basis of information recorded in the request trace table 108 and object management table 112.

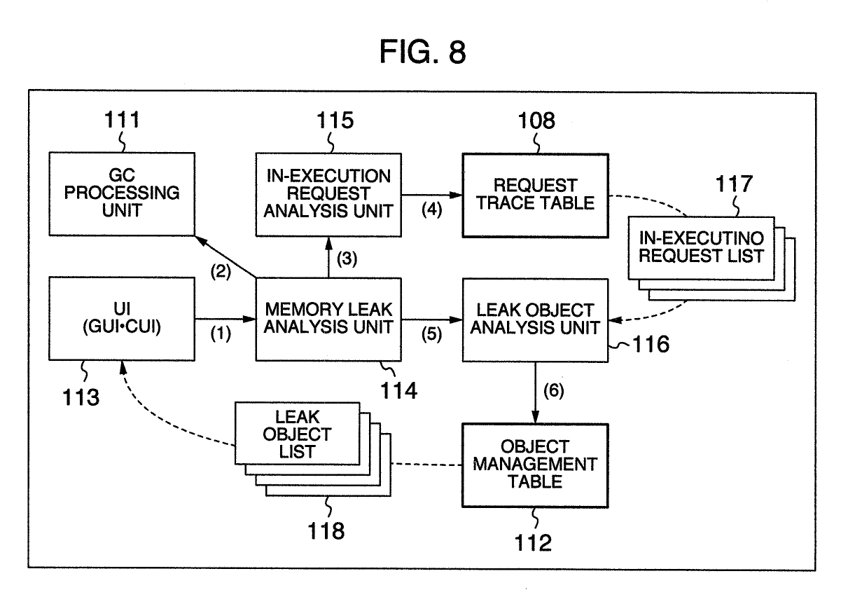

FIG. 8 is an explanatory diagram showing a general flow of a memory leak detection processing in the embodiment of the invention. Reference numerals in brackets annexed to arrows in FIG. 8 show a processing order. The memory leak detection processing is executed by accepting an instruction of user from the UI 113 in application server 30. In addition, the reference numerals in brackets annexed to the end of sentences correspond to those annexed to the arrows in FIG. 8.

The UI 113 requests the memory leak analysis unit 114 to acquire an object list (leak object list 118) indicating that an object having a suspicion of memory leak, referring to (1). Here, the object having a suspicion of memory leak is an object not released from a memory, even though a request which has created an object is already completed.

In addition, in the case where the object is released by the garbage collection, the memory leak analysis unit 114 requests the GC processing unit 111 to release the object so that an object that is not referred by either programs or objects is released, referring to (2). Further, in the case where the object is explicitly released from the memory by the user program 105, the object release processing may not be executed by the garbage collection.

When the object release is completed by the GC processing unit 111, the memory leak analysis unit 114 requests the in-execution request analysis unit 115 to acquire the in-execution request list 117, referring to (3). Meaning of the in-execution request list 117 is a list of requests which are not recorded as completion information of the requests in the request trace table 108 and not completed as a processing. A reason why the in-execution request list 117 is necessary is that this is because the object created by the request being processed is required to remove from the object list of objects having a suspicion of memory leak, at a time of detecting an object having the suspicion of memory leak. The in-execution request analysis unit 115 refers to the request trace table 108, referring to (4), to create the in-execution request list 117.

Further, the memory leak analysis unit 114 transmits the in-execution request list 117 created by the in-execution request analysis 115 to the leak object analysis unit 116 to request acquisition of the leak object list 118, referring to (5).

The leak object analysis unit 116 refers to the object management table 112 which makes the objects corresponding to the requests to search an object which corresponds to a request not included in the in-execution request list 117 and create the leak object list 118, referring to (6).

In addition, in the case where a request ID is recorded in the object, the leak object analysis unit 116 searches the object present in the user memory area 103 to create the leak object list 118. Specifically, an object is extracted from the objects, the request ID of which is recorded in the objects present in the user memory area 103, is not matched with the request ID included in the in-execution request list 117.

The memory leak analysis unit 114 transmits the leak object list 118 created by the leak object analysis unit 116 to the UI 113. The UI 113 displays a list of the objects having a suspicion of memory leak on a screen in accordance with the leak object list 118.

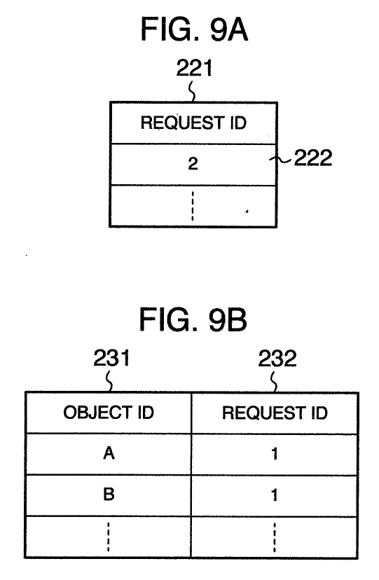

FIG. 9A is a diagram showing an example of the in-execution request list 117 created by the in-execution request analysis unit 115 in the embodiment of the invention.

The in-execution request list 117 is a table for storing the list of request ID 221 which uniquely identifies a request being executed at a time of detecting an object having a suspicion of memory leak.

Referring to FIG. 9A, a request ID “2” is stored in the in-execution request list 117 because the request indicating that the request ID is “2” is being executed.

FIG. 9B is a diagram showing an example of the leak object list 118 created by the leak object analysis unit 116 in the embodiment of the invention.

The leak object list 118 is a table for storing a list of object ID 231 for uniquely identifying objects having a suspicion of memory leak and request ID 232 for uniquely identifying requests created by the objects.

Referring to FIG. 9B, the objects indicating that the object ID 231 has “A” and “B” have a suspicion of memory leak, and it is appreciated that these objects have been created by the requests indicating that the request ID 232 is “1”.

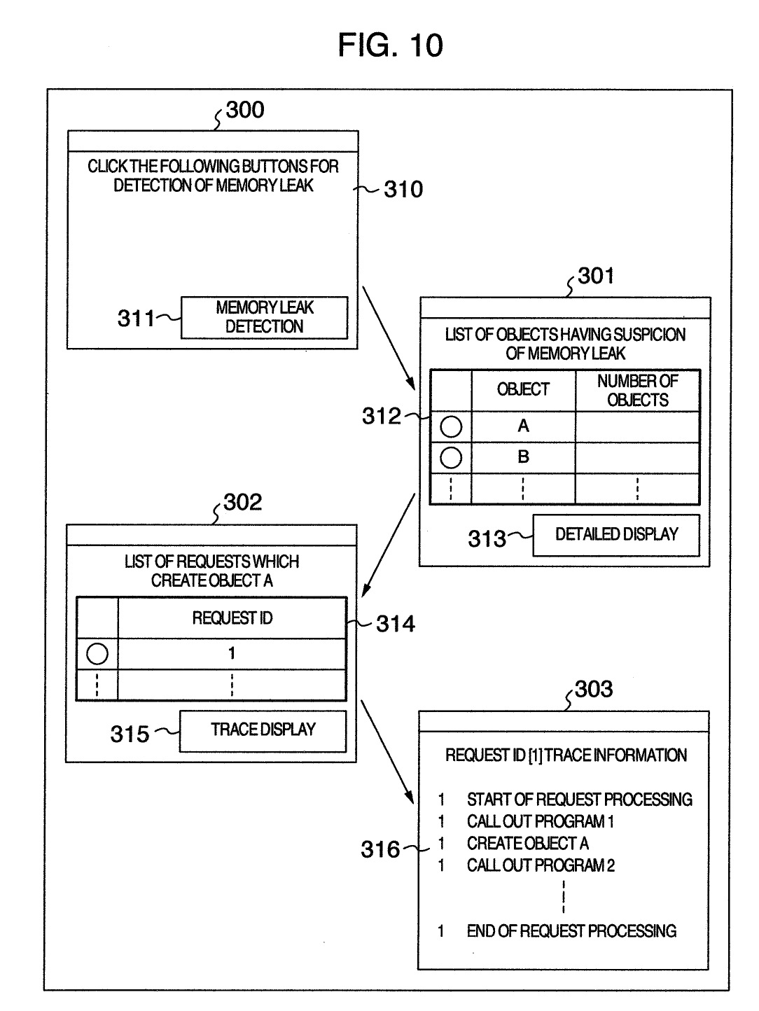

FIG. 10 is a diagram showing an example of GUI constitution of a memory leak detection program in the embodiment of the invention.

A screen 300 is a screen to accept an instruction of detecting memory leak from the user, and includes a message 310 for accepting the instruction of detecting memory leak and a button 311 for instructing the detection of memory leak.

When a memory leak detection is instructed by operating the button 311, the UI 113 requests the memory leak analysis unit 114 to acquire the leak object list 118 and display its content on a screen 301, after acquiring the leak object list 118 from the memory leak analysis unit 114.

The screen 301 is a screen to display an object list of the objects having a suspicion of memory leak, that is, displays a table 312 including a list of object names and number of objects having a suspicion of memory leak. The table 312 arranges radio buttons to select an object. By selecting the radio button and operating a detailed display button 313, a list of requests which create the selected objects can be displayed on the screen.

A screen 302 displays a list of the request IDs which create the selected object. The list of request ID which create the selected object is displayed by a table 314. The table 314 arranges radio buttons for selecting the request ID. By selecting the radio button arranged on the table 314 and operating a trace display button 315, trace information can be displayed for the request identified by the selected request ID.

A screen 303 displays trace information 316 of the request identified by the request ID selected by the radio button on the screen 302. The trace information includes, in time series order, a start and end of the request processing, an execution of the user program 105, a creation of the object, etc.

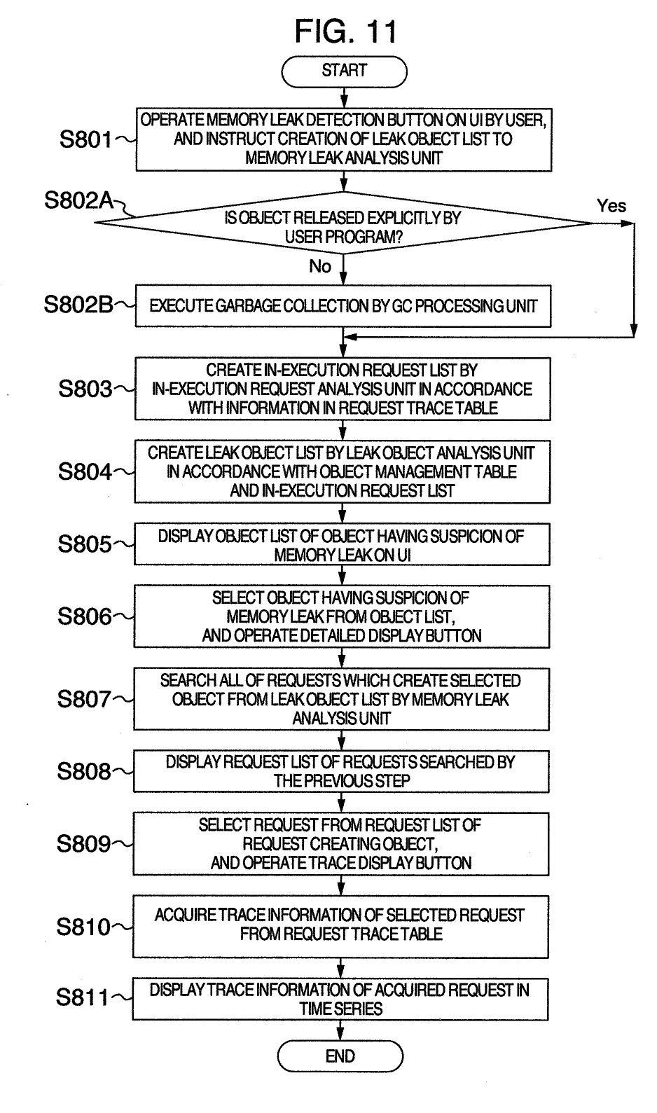

FIG. 11 is a flow chart showing steps of a memory leak detection processing in the embodiment of the invention. This flow chart shows a processing content in which an instruction from the UI 113 is accepted, an object list of the objects having a suspicion of memory leak is created, and trace information of the request which creates objects having a suspicion of memory leak is displayed eventually. A more specific example will be described with the request trace table 108 and object management table 112 shown in FIG. 2A and FIG. 2B. In addition, the memory leak detection processing is assumed that it is executed after the request, the request ID of which is “1”, is ended (the record 206 in FIG. 2A).

The UI 113 requests the memory leak analysis unit 114 to create the leak object list 118 by operating the memory leak detection button 311 on the screen 300 by the user (step S801).

The memory leak analysis unit 114 judges whether the object is released explicitly by the user program 105 (step S802A). If the system is not a type of explicitly releasing the object (a result of the step S802A is “No”), the execution of full garbage collection is requested for the GC processing unit 111 to release an object which is not referred from other objects (step S802B). Further, if the object is explicitly released by the user program 105 (the result of the step S802A is “Yes”), a step S803 may be executed without executing the object release processing.

The memory leak analysis unit 114 request the in-execution request analysis unit 115 to analyze the request being executed. The in-execution request analysis unit 115 refers to the request trace table 108 to create the in-execution request list 117 which does not record trace information at a time of the end of request processing (the step S803).

Here, referring to the request trace table 108 in FIG. 2A, the request being executed or the request processing is not ended becomes a request, the request ID of which is “2” because this request processing is being executed after the end of request, the request ID of which is “1”, as described above. Therefore, the in-execution request list 117 includes a record 222 storing “2” in a request ID 221, as shown in FIG. 9A.

The memory leak analysis unit 114 transmits the in-execution request list 117 acquired by the in-execution request analysis unit 115 in the step S803 to the leak object analysis unit 116. The leak object analysis unit 116 then creates, from the object management table 112, a list (leak object list 118) of the objects created by the request which is not being executed (or, the processing is already completed) (step S804).

A procedure of creating the leak object list 118 in FIG. 9B will be described specifically. First, the leak object analysis unit 116 refers to the in-execution request list 117 to specify a request ID of the request being executed. Referring to FIG. 9A, “2” is stored in the request ID 221. Subsequently, an object created by the request not included in the in-execution request list 117 is extracted from the object management table 112 in FIG. 2B, that is, an object created by the completed request in processing is extracted. Therefore, the request having a request ID other than “2”, that is, the objects “A” and “B” created by the request, the request ID of which is “1”, is extracted from the object management table 112 in FIG. 2B to create the leak object list 118.

The created leak object list 118 is displayed on the UI 113 (the object list 312 of screen 301 in FIG. 10) (step S805).

Subsequently, the user operates the detailed display button 313 on the screen 301 to select an object for checking a detail from the list of objects having a suspicion of memory leak displayed on the UI 113 (step S806).

The memory leak analysis unit 114 searches all of requests which have created the object as selectively checked object from the leak object list 118 created by the step S804 (step S807). The searched request is then displayed on the UI 113 (the request list 314 on the screen 302 in FIG. 10) (step S808).

Referring to the screen 302 in FIG. 10, the object “A” is selected. Referring to the leak object list 118 in FIG. 9B, it is appreciated that the object “A” is created by the request, the request ID of which is “1”.

Further, the user selects a request for displaying detailed trace information from the request list 314 displayed on the screen 302 to operate the trace display button 315 (step S809). The memory leak analysis unit 114 then searches trace information of the selected request from the request trace table 108 (step S810). Finally, the trace information of the searched request is displayed on the UI 113 (the screen 303 in FIG. 10) in a time series order (step S811). The trace information of the request, the request ID of which is “1”, is displayed on the screen 303 in FIG. 10.

The request trace table 108 records the trace information of all of the requests. Because of this, the number of pieces of trace information included in the request trace table 108 becomes continuously increased with elapse of time. Therefore, it is necessary to delete the trace information of the unnecessary request from the request trace table 108.

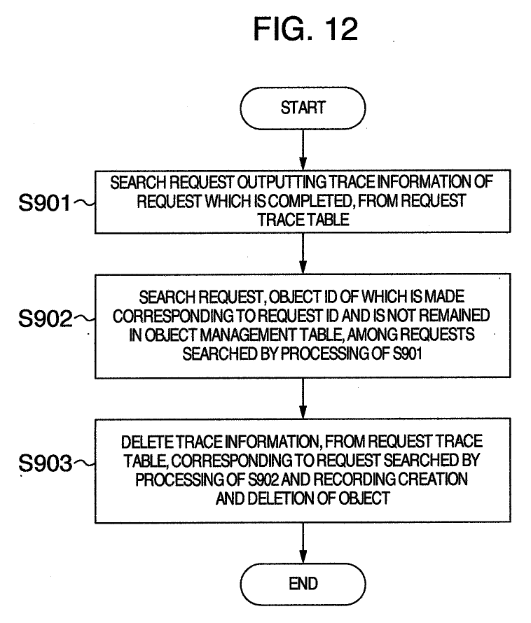

FIG. 12 is a flow chart showing steps of deleting the trace information stored in the request trace table 108 in the embodiment of the invention. In addition, a trace information deletion processing may be executed either for each of the predetermined time periods, or for a case where the number of records of the trace information stored in the request trace table 108 exceeds a threshold value.

The trace information to be deleted is of a processing completed request, and of trace information relative to a request which does not occur a memory leak by the object created by the request. The trace information is also a record of recording information for creation and release of object.

The request trace unit 107 searches all of the requests from the request trace table 108 which records the trace information of the processing completed requests (step S901).

Further, the request trace unit 107 narrows down the requests acquired by the step S901 to the requests created by this step and completely released all of the objects created by the request (step S902). In addition, whether the objects created by the request are released completely is judged by confirming that the object created by the request is not registered in the object management table 112.

Finally, the request trace unit 107 has a request ID of the request narrowed down by the step S902 to delete, from the request trace table 108, the trace information which records the creation and release of object (step S903).

By the processing described above, the record of the creation and release of objects is deleted from the request trace table 108, other than the normal trace information such as a program execution etc., for the request which does not occur a memory leak. The record of creation and release of the object becomes unnecessary for the request which is normally processed and completed without occurring a memory leak, because detection and cause of memory leak are recorded. Consequently, the record which records the creation and release of object is deleted, so that a capacity for storing the trace information can be reduced.

According to the embodiment of the invention, a history (trace information) of the event having occurred from the acceptance of request to the end of processing is recorded in the request trace table 108, when the request accepted from a user is processed. Further, the created object is made corresponding to the request to record in the object management table 112 because of processing the accepted request. Therefore, it is possible that an object having a suspicion of memory leak is extracted on the basis of information stored in the request trace table 108 and object management table 112.

Furthermore, according to the embodiment of the invention, the timing and before and after processing for the creation of object which occurs a memory leak can be specified since the trace information is recorded in the request trace table 108. Therefore, it is possible to specify easily a condition of occurring a memory leak.

It should be further understood by those skilled in the art that although the foregoing description has been made on embodiments of the invention, the invention is not limited thereto and various changes and modifications may be made without departing from the spirit of the invention and the scope of the appended claims.

1. A memory leak detection method of detecting a memory leak of a processing executed in accordance with an accepted request in an application server including an interface, a processor connected with the interface, an accessible memory from the processor, and a storage device for storing a program and data, wherein
the processor executes the steps of:
corresponding the accepted request with an identifier to be specified to the accepted request to record a history of the processing executed in accordance with the accepted request as request trace information;
recording correspondence information of the accepted request and an object created in a processing of the accepted request when the object is created in the processing of the accepted request, and recording the creation of object created in the processing of the accepted request in the request trace information;
deleting the correspondence information of the accepted information and a use ended object when the use of object created in the processing of the accepted request is ended, and recording a release of the completely use object in the request trace information;
acquiring a request list in execution by searching requests, an ending history of which is not recorded in the request trace information, when the application server accepts an instruction to detect a memory leak; and
detecting an object corresponding to the request as an object having a suspicion of memory leak, wherein the object corresponding to the request is not included in the acquired request list in the execution and is included in the correspondence information of the accepted request and the object created in the processing of the accepted request.

2. The method according to claim 1, wherein the correspondence information of the accepted request and the object created in the processing of the requested request is recorded in object management information for managing the object created in the processing of the accepted request.

3. The method according to claim 1, wherein the correspondence information of the accepted request and the object created in the processing of the requested request is recorded in the object created in the processing of the accepted request.

4. The method according to claim 1, wherein the processor displays a list of detected objects having a suspicion of memory leak.

5. The method according to claim 4, wherein the processor accepts a selection from the detected objects having the suspicion of memory leak, and displays a list of requests which have created the selected objects having the suspicion of memory leak.

6. The method according to claim 5, wherein the processor accepts a selection from the requests which have created the selected object, extracts a history of the selected request from the request trace information, and displays the history of the extracted request in a time series order.

7. The method according to claim 1, wherein the processor executes a processing for releasing an object which is not referred from other objects at a time after accepting an instruction of detecting the memory leak and before detecting the object having the suspicion of memory leak.

8. The method according to claim 1, wherein the processor executes, in a predetermined timing, the steps of:
searching the request, the ending history of which is recorded, from the request trace information;
extracting the request which is searched as the request, the processing of which is ended, and is not recorded with the object corresponding to the correspondence information of the accepted request and the object created in the processing of the accepted request; and
deleting trace information which is of the processing executed by the extracted request, and records a creation and release of the object, from the request trace information.

9. The method according to claim 8, wherein the processor deletes periodically the trace information which is of the processing executed by the extracted request and records the creation and release of the object, from the request trace information.

10. The method according to claim 8, wherein the processor deletes the trace information which is of the processing executed by the extracted request and records the creation and release of the object, from the request trace information.

11. A memory leak detecting device for detecting a memory leak of an executed processing, and including an interface, a processor connected with the interface, an accessible memory from the processor, and a storage device for storing a program and data, comprising:
a request acceptance unit that accepts a request including a business processing;
a request trace unit that corresponds the accepted request with an identifier to be specified to the accepted request to record, as request trace information, a history of a processing executed in accordance with the accepted request, a creation of an object created in the processing of the accepted request, and a release of a use ended object when a use of the object created in the processing of the accepted request is ended;
an object management unit that records correspondence information of an identifier for specifying the accepted request and an identifier for specifying the object created in the processing of the accepted request when the object is created in the processing of the accepted request, and deletes the correspondence information of the accepted request and the use ended object when a use of the object created in the processing of the accepted request; and
a memory leak analysis unit that acquires a request list in execution by searching requests, an ending history of which is not recorded in the request trace information, when an instruction for detecting a memory leak is accepted, and detects an object corresponding to the request as an object having a suspicion of memory leak, wherein the object corresponding to the request is not included in the acquired request list in the execution and is included in the correspondence information of the accepted request and the object created in the processing of the accepted request.

12. A computer readable program for a memory leak detection of a processing executed by a computer in accordance with an accepted request, the computer executes the steps of;
corresponding the accepted request with an identifier to be specified to the accepted request to record, as request trace information, a history of a processing executed in accordance with the accepted request;
recording correspondence information of an identifier for specifying the accepted request and an identifier for specifying the object created in the processing of the accepted request, when an object is created in the processing of the accepted request;
recording the creation of object created in the processing of the accepted request;
deleting the correspondence information of the accepted request and a use ended object when a use of the object created in the processing of the accepted request is ended;
recording a release of the use ended object in the request trace information;
acquiring a list of the requests in execution by searching a requests, an ending history of which is not recorded in the request trace information, when the computer accepts an instruction for detecting a memory leak; and
detecting an object corresponding to the request as an object having a suspicion of memory leak, wherein the object corresponding to the request is not included in an acquired request list in execution and is included in the correspondence information of the accepted request and the object created in the processing of the accepted request.
